(19) United States
(12) Patent Application Publication
(10) Pub. No.: US 2004/0018427 A1
(43) Pub. Date: Jan. 29, 2004

(54) Battery life extender additives

(76) Inventor: Robert A. Monconduit, Placerville, CA (US)

Correspondence Address: ROBERT A. MONCONDUIT, 1832 CEDAR OAK ROAD, PLACERVILLE, CA, 95667, US

(21) Appl. No.: 10/377,646

(22) Filed: Mar. 4, 2003

Related U.S. Application Data
(60) Provisional application No. 60/361,008, filed on Mar. 4, 2002.

(51) Int. Cl. H01M 10/08; H01M 10/26

(52) U.S. Cl. 429/205; 429/206; 429/207

(57) ABSTRACT

The present invention relates to chemicals or a combination of chemicals for optimizing the function of a new and already in service lead-acid battery over a long period of time, reducing corrosion on the positive plate, restoring lost capacity due to the accumulation of non-conductive lead sulphate crystals on plates, reducing charging time, and for starting batteries increasing cold crank rating.

The chemicals, Sodium Hydroxide and Sodium Tetraborate Decahydrate, can be used separately or in combination either in their solid form or dissolved in de-ionized water.

Other chemicals, Sodium Chloride and Boric Acid can be used in combination either in their solid form or dissolved in de-ionized water.

Those chemicals can be effective in all types of lead-acid batteries, including flooded (wet), gel and absorbed glass mat (AGM) lead-acid VRLA (Valve Regulated Lead Acid) batteries used as starting, storage, power, standby (back-up and Uninterrupted Power System), marine, industrial batteries.

### CROSS-REFERENCE TO RELATED APPLICATIONS

References Cited

U.S. Patent Documents

Villarreal-Dominguez, U.S. Pat. No. 3,964,927, Roland Greene, U.S. Pat. No. 4,617,244, Komoda, U.S. Pat. No. 5,738,956, John Willis, U.S. Pat. No. 5,945,236,

### FIELD OF THE INVENTION

The present invention relates to chemicals or a combination of chemicals for optimizing the function of a new and already in service lead-acid battery over a long period of time, reducing corrosion on the grids of positive plate, restoring lost capacity due to the accumulation of non-conductive lead sulphate crystals on plates, reducing charging time, and for starting batteries increasing cold crank rating.

### DEFINITIONS OF TERMS USED IN THIS APPLICATION (BATTERY COUNCIL INTERNATIONAL)

Active Material.—Is lead dioxide in the positive plates and metallic sponge lead in the negative plates. These materials react with sulfuric acid during charging and discharging, when an electrical circuit is created and according to the following chemical reaction:

PbO2+Pb+2H2SO4=2PbSO4+2H2O

Ampere—It is the unit of measure of the electron flow rate.

Ampere-Hour (Amp.-Hr, AH)—It is the unit of measure for a battery's electrical capacity.

Capacity—It is the ability of a fully charged battery to deliver a specified quantity of electricity (Amp-Hr., AH), at a given rate (Amp,A) over a definite period of time (Hr).

Cell—It is the basic electrochemical current-producing unit in a battery, consisting of a set of positive plates, negative plates, electrolyte, separators, and casing.

Circuit—An electric circuit is the path followed by a flow of electrons. A closed circuit is a complete path. An open circuit has a broken or disconnected path.

Cold Crank Rating—The number of amperes a lead-acid battery at 0□F (−17.8° C.) can deliver for 30 seconds and maintain at least 1.2 volts per cell.

Corrosion—This is the destructive chemical reaction of a liquid electrolyte with a reactive material.

Current—This the rate of flow of electricity, or the movement of electrons along a conductor. The unit of measure for current is the ampere.

Cycle—In a battery, one discharge and one recharge is one cycle.

Discharging—When a battery is delivering current, it is said to be discharging.

Electrolyte—In a lead-acid battery, the electrolyte is sulfuric acid diluted with water. It is a conductor that supplies water and sulfate for the electrochemical reaction:

PbO2+Pb+2H2S04=2PbSO4+2H2O

Resistance—The opposition to the free flow of current in a circuit, It is commonly measured in Ohms.

Specific Gravity—The density of a liquid compared to the density of water. The specific gravity of the electrolyte is the weight of the electrolyte compared to the weight of an equal volume of pure water.

How a battery operates—When two unlike materials such as a positive and negative plates are immersed in sulfuric acid (the electrolyte), a battery is created and a voltage is developed. The voltage developed depends upon the types of materials used in the plates and the electrolyte used. The voltage is approximately 2.1 volts per cell in a typical lead-battery.

### BACKGROUND OF THE INVENTION

It is well known that the main causes of lead-acid battery failure are by-products of the normal chemical process that takes place in a cell. Over time, formation and accumulation of insoluble hard lead sulphate crystals (sulphation) on plates keep the chemical reaction from happening normally. Deterioration of the positive plate grid also occurs with material separation from the grid.

A positive plate is made of lead dioxide (PbO2) which is a compound of lead (Pb) and oxygen, and electrolyte, a diluted sulfuric acid, is a compound of hydrogen (H2) and sulfate radical (SO4).

During the discharge cycle, lead (Pb) in the active material on the positive plate combines with the sulfate (SO4) of the sulfuric acid forming lead sulfate (PbSO4) in the positive plate. Oxygen (O) in the active material of the positive plate combines with Hydrogen (H) from the sulfuric acid to form water (H2O) which reduces the concentration of acid in the electrolyte.

On the negative plate, a similar reaction is happening where Lead (Pb) from the active material combines with sulfate (SO4) from the sulfuric acid to form lead sulfate (PbSO4) in the negative plate.

During discharge, the active material of both plates is being converted to lead sulfate (PbSO4). The plates are becoming more alike and the acid is becoming weaker. If the battery is subject to a high discharge rate, acid circulation into the pores of the plates and diffusion of water from the pores of such plates is too slow to sustain the discharge. It is well known that during cold discharges, the more porous and low density is the plate material, the more movement of acid into the plates and water from the pores of the plates takes place.

When a discharged storage battery is recharged its active materials will be restored to their original composition, as the chemical reactions that take place within a battery during charge are basically the reverse of those that occur during discharge. The sulfate (PbSO4) in both plates is split into its original form of lead (Pb) and sulfate (SO4). The water is split into hydrogen (H) and oxygen (O). As the sulfate leaves the plates it combines with the hydrogen and is restored to sulfuric acid (H2SO4). At the same time, the oxygen combines chemically with the lead of the positive plate to form lead dioxide (PbO2). The specific gravity of the electrolyte increases during charge because sulfuric acid is being formed and is replacing water in the electrolyte.

A battery will evolve gas when it is being charged. Hydrogen is given off at the negative plate and oxygen at the positive. These gases result from the decomposition of water H2O). A battery gases (and uses water) because it is being charged at a higher rate than it can accept. This may be due to the fact that the battery has its plates sulfated, and/or corroded or that it is too cold to accept a charge.

### DESCRIPTION OF RELATED ART

It is well known that excess sulphation remaining on plates is what frequently makes a battery stop working way before its normal number of cycles is completely spent. This condition can be inhibited as shown by Villarreal-Dominguez, U.S. Pat. No. 3,964,927, Roland Greene, U.S. Pat. No. 4,617,244, Komoda, U.S. Pat. No. 5,738,956, John Willis, U.S. Pat. No. 5,945,236. However, it may take a relatively long time after the electrolyte of a battery is treated to see positive results and it may require an additional treatment on a regular basis to continue solving the problem.

It is also well know that corrosion on the positive plates is what makes the battery fail irremediably. Reducing corrosion of the positive plates gives a battery a longer life that can be close to the full life span designed by the manufacturer.

The above inventions do not provide a solution to:

rapidly restore the normal condition of a battery

reduce and prevent corrosion on the grid of the positive plate.

control internal electrical resistance

prevent damage in VLRA batteries

According to this invention, the main aim of those additives is to:

1. Restore and increase the capacity of a battery.

2. Increase the useful life of a battery.

3. Reduce maintenance of a battery.

4. Reduce level of bubbling during the charging phase of a battery.

5. Prevent and reduce corrosion on the terminal posts of a battery.

6. Dissolve sulphation deposited in the bottom of the casing of a battery to reduce the level of sediment containing lead material from the plates and prevent its contact with the bottom of the plates.

7. Inhibit non-conductive hard lead-sulfate crystals and prevent their formation on the plates.

8. Reduce and prevent corrosion on the grid of the positive plate.

9. Restore and equalize electrolyte specific gravity and voltage of each cell of a battery.

10. Control electrical resistance.

11. Prevent damage in VLRA batteries.

### SUMMARY OF THE INVENTION

The present invention relates to chemicals and combination of chemicals that when added to the electrolyte can increase the life of a new and used lead-acid battery.

It is an object of at least some embodiments of the present invention to increase the useful life of a battery.

It is also an object of at least some embodiments of the present invention to restore and increase the capacity of a battery.

It is also an object of at least some embodiments of the present invention to reduce the maintenance of a battery.

It is also an object of at least some embodiments of the present invention to reduce the level of bubbling during the charging phase of a battery.

It is also an object of at least some embodiments of the present invention to prevent and reduce corrosion of battery terminal posts.

It is also an object of at least some embodiments of the present invention to reduce the amount of sediments in the bottom of the casing of a battery that otherwise can be in contact with the plates, creating shorts or draining the battery.

It is also an object of at least some embodiments of the present invention to inhibit hard lead sulphate crystals and prevent their formation on plates of a battery.

It is also an object of at least some embodiments of the present invention to reduce and prevent corrosion on the grid of a positive plate.

It is also an object of at least some embodiments of the present invention to restore and equalize the normal specific gravity and voltage in each cell of a battery.

It is also an object of at least some embodiments of the present invention to prevent damage in sealed VRLA (Valve Regulated Lead-Acid) of flooded, gel or absorbed glass mat (AGM) battery types.

Ingredients

In accordance with other preferred embodiments of the present invention, the ingredients are:

Sodium Hydroxide

Sodium Tetraborate Decahydrate

Sodium Chloride

Boric Acid

Those ingredients are used separately or in combination either in their solid form or dissolved in de-ionized water.

Preferably, the above chemical(s) is (are) mixed to de-ionized water as follows:

A) 0.5% to 5% in weight of Sodium Hydroxide to the remaining balance of de-ionized water.

B) 0.5% to 5% in weight of Sodium Tetraborate Decahydrate to the remaining balance of de-ionized water.

C) 0.5% to 5% in weight of Sodium Hydroxide, and 0.5% to 5% of Sodium Tetraborate Decahydrate to the remaining balance of de-ionized water.

D) 0.5% to 5% in weight of Sodium Chloride, and 0.5% to 5% of Boric Acid to the remaining balance of de-ionized water.

To optimize the beneficial effects described in the summary of the present invention, preferably, a mixture of Sodium Hydroxide and Sodium Tetraborate Decahydrate (Formula C) should be used.

Ideally, the liquid solution of the formula B and C should comprise a quantity of Sodium Tetraborate Decahydrate less than 2.5 grams per liter of treated electrolyte and the liquid solution of the formula D should comprise a quantity of Boric Acid less than 2.5 grams per liter of treated electrolyte.

These benefits can be obtained with a one-time treatment (formula C and D) and as shown by the observations obtained from extensive experiments conducted in my laboratory during a period of 18 months under charging, discharging, measurement of specific gravity, temperature readings, and discharge resistance controlled conditions.

### DESCRIPTION OF DRAWINGS

FIG. 1. Rise of temperature during the discharge cycle

FIG. 2. Rise of temperature during the charge cycle

FIG. 3. Comparative graph illustrating liquid loss averages in untreated batteries “cycled” for 120 hours as compared to liquid loss in treated cells.

FIG. 4. Degree of Sulphation based on Scale of Hardness.

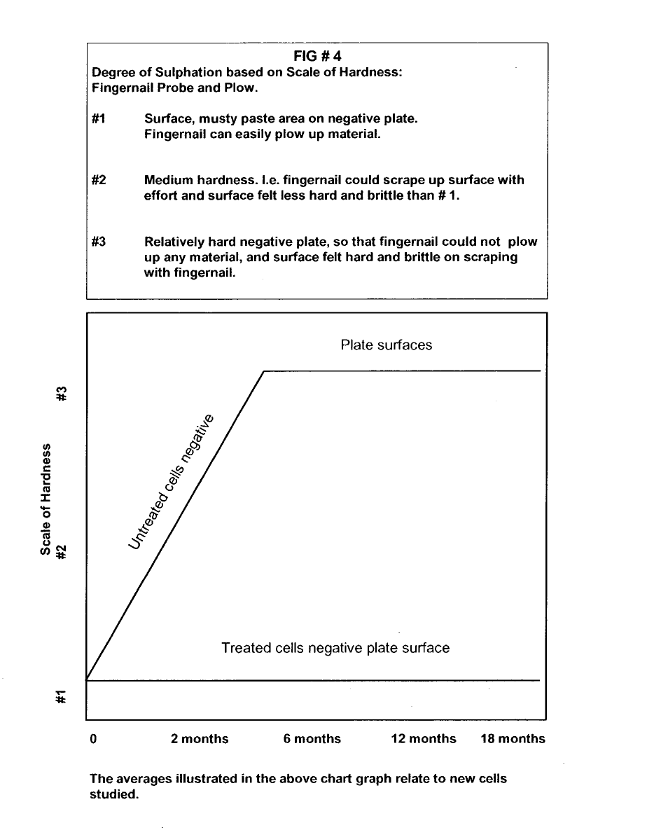

FIG. 5. BR01—Cycle life—Charge & discharge rates after 100 cycles—KERI report

FIG. 6. BR01—Cycle life—Charge & discharge rates after 10 cycles—KERI report

### DESCRIPTION OF THE INVENTION

The description of the present invention derives from observations on experimental work conducted with starting batteries of the same size and brand: Voltage 12V, Cells 6, 200 amps, electrolyte specific gravity 1.270 @ 72° F. Those batteries were tested every 2 days, 1 day testing and 1 day to let them cool down. They were applied a charge of 10 Amps during 6 hours and then a draw of 10 amps discharge during 6 hours. The number of cycles applied was 270.

GROUP I—50 Identical New Flooded Lead-acid Batteries activated the same day the experimental work started.

Group I-A—10 were used as reference

Group I-B—40 were used as follows:

Group I-B with formula A

10 were treated once with the solution comprising of 0.5% to 5% in weight of Sodium Hydroxide to the remaining balance of de-ionized water referred as formula A

Group II-B with formula B

10 were treated once with the solution comprising of 0.5% to 5% in weight of Sodium Tetraborate Decahydrate to the remaining balance of de-ionized water referred as formula B.

Group II-B with formula C

10 were treated once with the solution comprising of 0.5% to 5% in weight of Sodium Hydroxide, and 0.5% to 5% of Sodium Tetraborate Decahydrate to the remaining balance of de-ionized water referred as formula C.

Group II-B with formula D

10 were treated once with the solution comprising of 0.5% to 5% in weight of Sodium Chloride, and 0.5% to 5% of Boric Acid to the remaining balance of de-ionized water referred as formula D.

GROUP II—50 IDENTICAL SULPHATED FLOODED LEAD-ACID MECHANICALLY SOUND—24 MONTHS OLD—BATTERIES.

Group II-A—10 were used as reference

Group II-B—40 were used as follows:

Group II-B with formula A

10 were treated once with the solution comprising of 0.5% to 5% in weight of Sodium Hydroxide to the remaining balance of de-ionized water referred as formula A.

Group II-B with formula B

10 were treated once with the solution comprising of 0.5% to 5% in weight of Sodium Tetraborate Decahydrate to the remaining balance of de-ionized water referred as formula B.

Group II-B with formula C

10 were treated once with the solution comprising of 0.5% to 5% in weight of Sodium Hydroxide, and 0.5% to 5% of Sodium Tetraborate Decahydrate to the remaining balance of de-ionized water referred as formula D.

Group II-B with formula D

10 were treated once with the solution comprising of 0.5% to 5% in weight of Sodium Chloride, and 0.5% to 5% of Boric Acid to the remaining balance of de-ionized water referred as formula D.

The observations are as follows:

GROUP I—New Batteries

Observations after 18 months of continuous charge/discharge cycles:

a) A new lead acid battery is not harmed by the presence of the chemicals of each formula in each cell.

b) The negative plates of cells treated with the formula A have shown no shedding of active material and the material was in a softer condition than untreated cells of the Group I-A, However the grid of positive plates have shown signs of corrosion.

c) Surprisingly, the grid of positive plates of cells treated with the formula B where free of corrosion compared to the corroded untreated cells of the Group I-A showing signs of material separation from the grid.

d) The negative plates of cells treated with the formula C have shown no shedding of active material and the material was in a softer condition than untreated cells of the Group I-A. The grid of positive plates of cells treated with the formula C were virtually free of corrosion compared to the corroded untreated cells of the Group I-A showing signs of material separation from the grid.

e) The negative plates from treated cells with the formula C have shown a softer and finer texture of the metallic sponge lead, their color being gray. However, in those untreated cells of the Group I-A, the light white color of the lead was very clearly defined in the grids and the material was quite hard and brittle. Treated cells of the Group I-B were in better condition mechanically than untreated cells of the Group I-A.

f) Same observations as d) and e) when treated with formula D, however positive plates were slightly corroded.

g) Under identical conditions of charge, cells treated with the formula A, C and D resulted in a higher specific gravity reading in less time than similar untreated cells of the Group I-A.

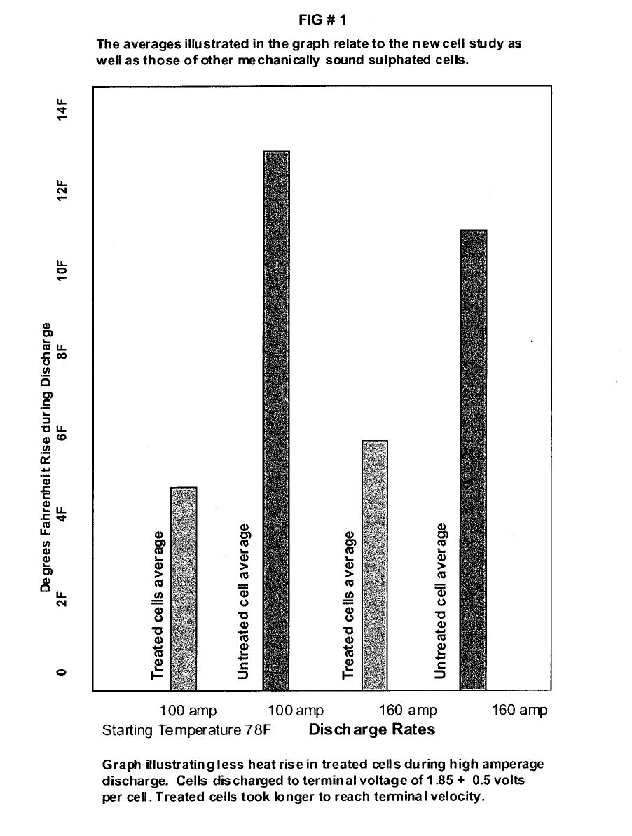

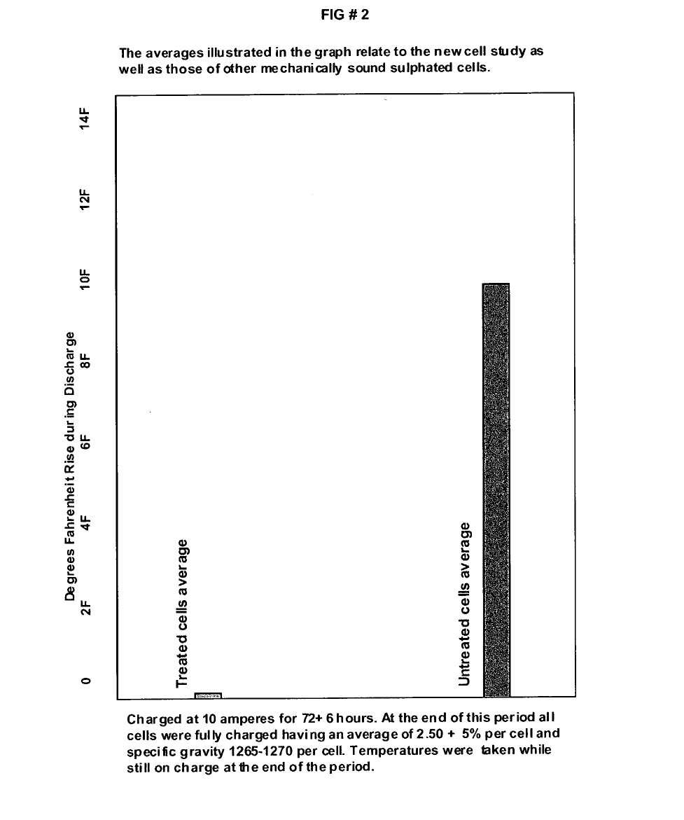

h) Under identical conditions of charge and discharge, on the average those cells treated with formula A, B, C or D operated cooler than the untreated cells of the Group I-A. However it resulted cooler with the formula C (See FIG. 1 and FIG. 2).

i) Upon comparison with untreated cells, those cells treated with the formula A, B, C or D indicated a more effective, that is, higher charging efficiency than untreated cells of the Group I-A. However it resulted more efficient with the formula C.

j) Separators in treated batteries of the Group I-B appeared to suffer less physical deterioration than the separators of untreated batteries of the Group I-A.

k) When the battery was on charge and when it was not on charge, the amount of sediment deposited in the bottom of the casing of treated batteries of the Group I-B was insignificant or non existent in those treated with the formula A, C and D. Sediment was clearly visible in those untreated cells of the Group I-A.

l) When agitated in a jar, the electrolyte from cells of treated batteries of the Group I-B remained clear when treated with the formula A, C and D compared to those untreated of the Group I-A showing material in suspension.

m) Under proper charging conditions, gas bubbles evolving in the treated cells of the Group I-B when treated with the formula A, B and D were smaller and distinctively different, and with the formula C much smaller than those evolved in the untreated cells of the Group I-B. They appeared to evolve only at the end of the charging cycle just before the battery was completely charged. In untreated cells of the Group I-A, bubble size was larger and cells emitted large quantities of dangerous gassing (hydrogen and other hazardous gases) essentially due to the increasing electrical resistance. The gassing of untreated cells was splashing the area of the experimental work and had to be contained.

n) During the 18 months of the experiment, terminal posts of the untreated batteries of the Group I-A needed to be cleaned on a regular basis as they were increasing electrical resistance due to the excessive gassing. Terminal posts of the Group I-B have been cleaned only once.

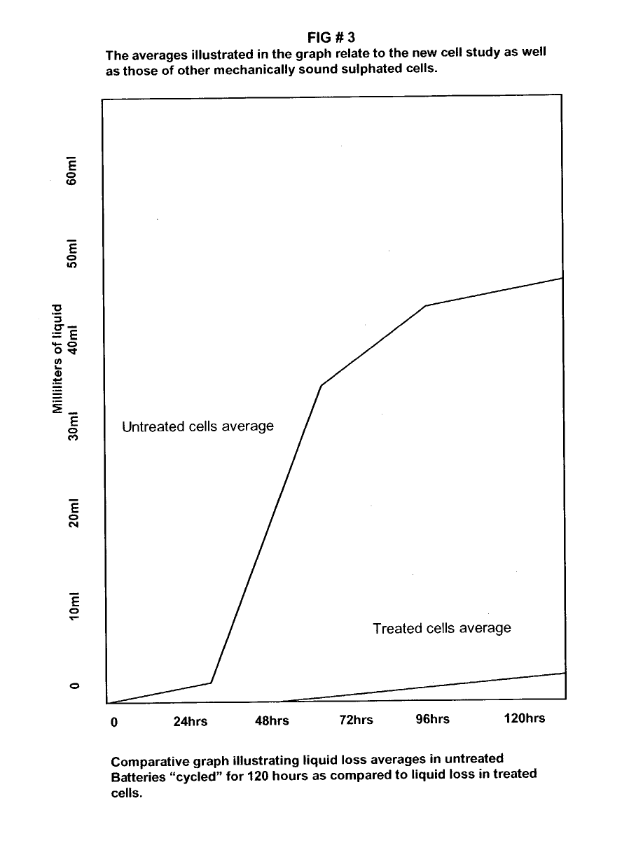

o) Untreated cells of the Group I-A, averaged 90% more liquid loss, than the treated cells of the Group I-B (see FIG. 3) treated with the formula C and D.

After 18 months, 100% of those batteries were still working satisfactorily.

GROUP II—36-Month Old Sulphated Batteries

Observations after 18 months of continuous charge/discharge cycles:

a) A sulphated lead acid battery is not harmed by the presence of the chemicals of each formula in each cell.

b) The gray active metallic sponge lead material of negative plates of cells treated with the formula A was in a softer condition and had much less shedding than untreated cells of the Group II-A. However the grid of positive plates were corroded.

c) Corrosion on the grid of positive plates of cells treated with the formula B was much less and grids were firmer when compared to the corrosion of grids of untreated cells of the Group II-A showing signs of degradation and material separation from the grid. The metallic sponge lead material of negative plates of cells treated with the formula C and D was found in a softer condition and shedding of active material was of the same level as those in the 36-month old sulphated battery prior the start of the experiment. In those treated cells, hard and brittle condition of the sulphated plate is inhibited and the desirable soft, spongy, porous material of the negative plate is restored. The untreated cells of the Group II-A were damaged with a substantial amount of active material lying in the bottom of the casing. The grid of positive plates of cells treated with the formula C and D were much less corroded than those of the 36-month old sulphated battery prior the start of the experiment. They were in a much better condition compared to the corroded untreated cells of the Group II-A showing degradation and signs of material separation from the grid.

d) The negative plates of sulphated battery cells treated with the formula C and D have shown a softer and finer texture of the metallic sponge lead material, their color being gray. However, in those untreated cells of the Group II-A, the light white to red-brown color of the lead was defined in the grids and was very brittle indicative of the presence of sulphation. Treated cells of the Group II-B were in better condition mechanically than untreated cells of the Group II-A.

e) Under identical conditions of charge, cells treated with the formula A, C and D resulted in a higher specific gravity reading in less time when starting with discharged, moderately sulphated cells of the Group II-A.

f) Under identical conditions of charge and discharge, on the average those sulphated cells treated with formula A, B, C or D operated cooler than the untreated cells of the Group II-A However as with the new batteries it resulted cooler with the formula C. (See FIG. 1 and FIG. 2).

g) Upon comparison with untreated sulphated cells, those cells treated with the formula A, B, C or D indicated an almost instant and higher charging efficiency than untreated cells of the Group II-A and were in better conditions mechanically. However it resulted more efficient with the formula C.

h) Separators in sulphated treated batteries of the Group II-B appeared to suffer less physical deterioration than the separators of untreated batteries of the Group II-A that continued to deteriorate.

g) When the sulphated batteries were on charge and when they were not on charge, the level of sediment deposited in the bottom of the casing of treated batteries of the Group II-B was less in those treated with the formula A, C and D. Sediment was abundant in those untreated cells of the Group II-A.

h) When agitated in ajar, the electrolyte from cells of sulphated treated batteries of the Group II-B has much less particles in suspension when treated with the formula A, C and D compared to those untreated of the Group II-A showing a gray color from active material and sulphation.

k) After a relatively short period of time, the size of gas bubbles evolving in the sulphated battery treated cells of the Group II-B when treated with the formula A, B, and D was reduced. Inhibition of the non-conductive lead-sulphate crystals on the negative and positive plates, reduction of corrosion on the grid of the positive plates and diminution of the level of sediment (mixture of a lead suphate and active material) in the bottom of the casing lowers electrical internal resistance allowing electrons to flow more freely. When treated with the formula C the size of bubbles was much smaller than those evolved in the untreated cells of the Group II-B. They appeared to evolve only at the end of the charging cycle just before the battery was completely charged. In untreated cells of the Group II-A, bubble size was larger and cells emitted almost immediately large quantities of dangerous gassing (hydrogen and other hazardous gases) essentially due to the increasing electrical resistance. The gassing of untreated cells was splashing the area of the experimental work and had to be contained.

l) During the 18 months of the experiment, terminal posts of the sulphated untreated batteries of the Group II-A needed to be cleaned on a regular basis as they were increasing electrical resistance due to the excessive gassing. Terminal posts of the Group II-B have been cleaned much less frequently.

m) Untreated cells of the Group II-A, averaged 90% more liquid loss, than the treated cells of the Group II-B treated with the formula C.

n) Longevity of mechanically sound sulphated batteries

Group II-B with formula A

All batteries were still working after 18 months of continuous charge/discharge cycles.

Group II-B with formula B

One battery stopped working after 3 months and the 9 others were still functioning normally after 18 months of continuous charge/discharge cycles.

Group II-B with formula C

All batteries were still working normally after 18 months of continuous charge/discharge cycles.

Group II-B with formula D

One battery stopped working after 12 months while the 9 others continued functioning normally after 18 months of continuous charge/discharge cycles.

The Korea Electrotechnology Research Institute (KERI) has conducted a 3-month discharge rate cycle lab test in new sulphated batteries 12V/55 Ah Delcor batteries. One battery was treated with the Formula C, also called Longa-Batt, and one battery was not treated.

1) The batteries were charged by constant current of 9A until the battery voltage is equal to 14.4V. Then the batteries were charged by constant voltage of 14.4V until the charge current is equal to 5.5A at 20±5° C.

2) The batteries were stored during 1 hour at 20±5° C.

3) The batteries were discharged at a constant current of 9A until the battery voltage is equal to 10.5V at 20±5° C.

4) The batteries were stored during 1 hour at 20±5° C.

5) Above procedure (stage 1 to 4) was repeated by 100 times.

The 10^{th} cycle measurement shows that the charge rate in the treated battery is higher (45 Ah) than the charge rate measured in the untreated battery (37 Ah)

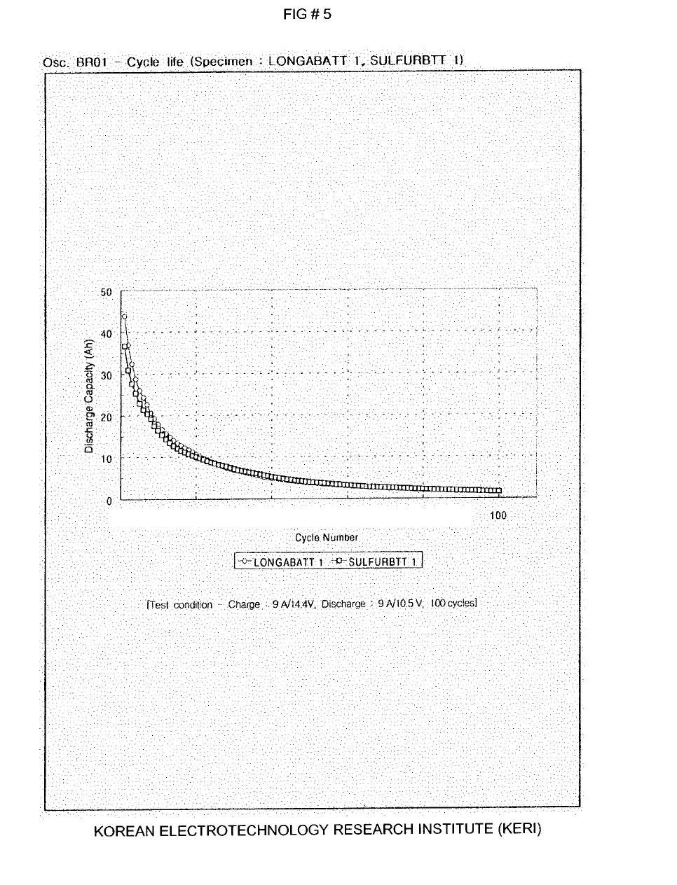

This is a 21% increase of capacity. See FIG. 5

The 100^{th} cycle measurement shows that a charge rate in the treated battery is higher (44 Ah) than the charge rate measured in the untreated battery (37 Ah)

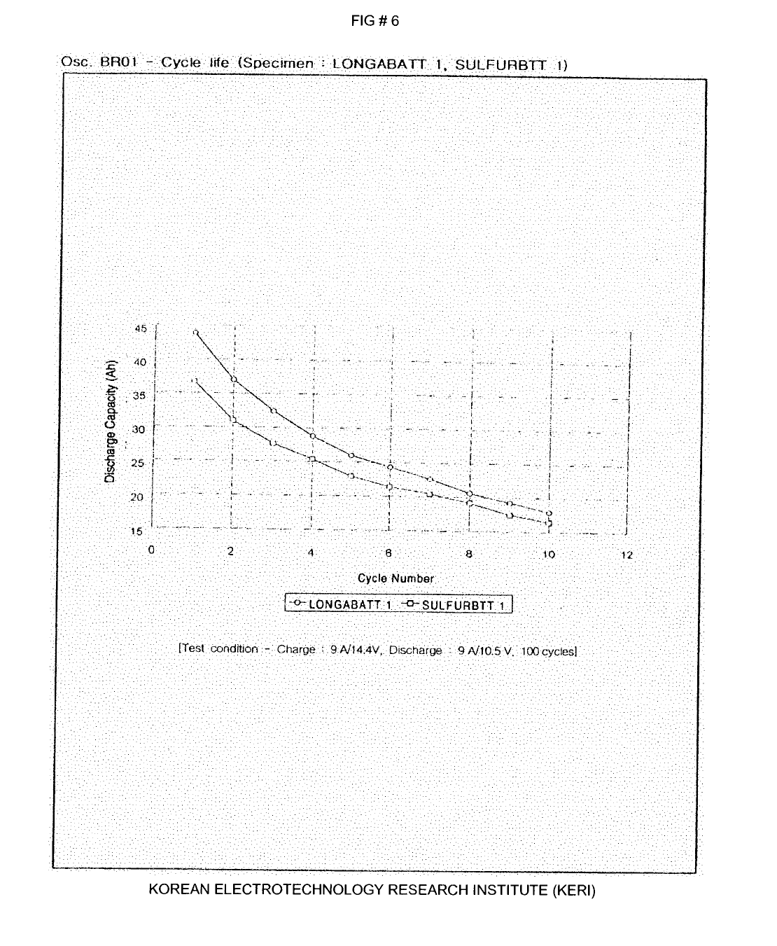

This is a 19% increase of capacity. See FIG. 6

This clearly shows an increase of capacity in the new battery treated with the Formula C.

Prevention and inhibition of corrosion on positive plates, inhibition of hard lead sulphate crystals on plates, and dramatic reduction of water loss are important resultants of this invention. This can result to longer life of all types of lead-acid batteries.

This is also true for Valve Regulated Lead-Acid (VRLA) batteries that, although sealed, periodically vent gases. This happens when positive plates start being corroded and if negative plates are sulphated as the consequence of leaving the battery undercharged. Electrical resistance build-up in all types of lead-acid batteries creates exponential internal heat, which combined with external heat, is detrimental to the life of a battery. A VRLA battery is more susceptible than other types of construction as those conditions in combination with overcharging, create internal pressure that can damage the plates, and loss of liquid that can hardly be replaced, thus shortening their life.

In all lead-acid batteries, control of internal electrical resistance by preventing corrosion on the positive plates and accumulation of insoluble hard lead sulphate crystals on plates is instrumental to reaching the maximum of cycles for which the battery has been designed.

Based on the those observations, this invention provides the essential conditions to maximize the life of a battery:

The formula A of this invention when added to the electrolyte of new or sulphated cells of a lead-acid battery, tends to prevent and inhibit deposits of insoluble hard lead sulphate crystals on the plates.

The formula B of this invention when added to the electrolyte of new or sulphated cells of a lead-acid battery prevents and tends to inhibit corrosion on the positive plates.

The formula C of this invention when added to the electrolyte of new or sulphated cells of a lead-acid battery tends to prevent and inhibit deposits of insoluble hard lead sulphate crystals on plates AND tends to prevent and inhibit corrosion on the positive plates.

The formula D of this invention when added to the electrolyte of a new and sulphated lead-acid battery, tends to prevent and inhibit deposits of insoluble hard lead sulphate crystals on plates AND tend to prevent and inhibit corrosion on the positive plates.

Although the mechanism of this invention is not well understood it has been observed:

that Sodium Hydroxide and possibly Sodium Tetraborate Decahydrate or the combination of the two chemicals added to sulfuric acid electrolyte of a lead-acid battery dissolve hard lead sulphate crystals that have accumulated on the plates. The same has been observed for the combination of Sodium Chloride and Boric Acid.

that Sodium Hydroxide or Sodium Chloride added to sulfuric acid electrolyte of a lead-acid battery helps increase the flow of electrons.

that Sodium Tetraborate Decahydrate or a combination of Sodium Hydroxide and Sodium Tetraborate Decahydrate, or Sodium Chloride and Boric Acid added to sulfuric acid electrolyte of a lead-acid battery tends to prevent or inhibit corrosion on positive plates.

I claim that:

1. An electrolyte additive made of sodium hydroxide or sodium tetraborate decahydrate or comprising a mixture of sodium hydroxide and sodium tetraborate decahydrate, or a mixture of sodium chloride and boric acid all in their solid form, or sodium hydroxide dissolved in de-ionized water, or sodium tetraborate decahydrate dissolved in de-ionized water, or a mixture of sodium hydroxide and sodium tetraborate decahydrate dissolved in de-ionized water or a mixture of sodium chloride and boric acid dissolved in de-ionized water.

2. An electrolyte additive described in claim 1 in which Sodium Tetraborate Decahydrate or Boric Acid quantity should be less than 2.5 grams per liter of treated electrolyte.

3. An electrolyte additive made of the chemicals described in claim 1 to inhibit hard lead suphate crystals deposits on plates, increase porosity of negative plates, reduce or inhibit corrosion on grids of positive plates, increase internal conductivity, restore and increase capacity, and in general increase the useful life of a lead-acid battery.

4. An electrolyte additive made of the chemicals described in claim 1 to accomplish the same purpose described in claim 3 and prevent or reduce potential damage in sealed VRLA (Valve Regulated Lead-Acid) of flooded, gel or absorbed glass mat (AGM) battery types.
